(19) United States
(12) Patent Application Publication
(10) Pub. No.: US 2007/0226115 A1
(43) Pub. Date: Sep. 27, 2007

(54) Methods and systems for providing deductible piers

(75) Inventors: Michael Sherman, Brooklyn, NY (US); Steven R. Halperin, New York, NY (US); Paul Robinson, New York, NY (US); Erin Callan, New York, NY (US); John Curran, Bronxville, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/651,375

(22) Filed: Jan. 8, 2007

Related U.S. Application Data
(63) Continuation-in-part of application No. 11/471,915, filed on Jun. 20, 2006.
(63) Continuation-in-part of application No. 11/295,276, filed on Dec. 5, 2005.
(60) Provisional application No. 60/756,823, filed on Jan. 6, 2006.
(60) Provisional application No. 60/837,000, filed on Aug. 11, 2006.

(51) Int. Cl. G06Q 40/00

(52) U.S. Cl. 705/36 R

(57) ABSTRACT

In one aspect, the invention comprises a security that: (a) is tax deductible; (b) receives equity credit of 40-75% from Moody's and S&P; and (c) qualifies for net share settled accounting. In another aspect, the invention comprises a method comprising: (a) structuring a convertible security to be tax deductible; (b) structuring the convertible security to receive equity credit of 40-75% from Moody's and S&P; (c) structuring the convertible security to qualify for net share settled accounting; and (d) issuing the security.

### CROSS-REFERENCE TO RELATED APPLICATIONS

This application claims the benefit of U.S. Provisional Application No. 60/756,823, filed Jan. 6, 2006, and U.S. Provisional Application No. 60/837,000, filed Aug. 11, 2006, and is a continuation-in-part of U.S. patent application Ser. No. 11/471,915, filed Jun. 20, 2006, and U.S. patent application Ser. No. 11/295,276, filed Dec. 5, 2005. The entire contents of each of those applications are incorporated herein by reference.

### BACKGROUND & SUMMARY

Two current structures available to issuers are trust preferred or perpetual preferred stock with equity enhancements (mandatory deferral). Perpetual preferred has become more attractive recently due to changes at the rating agencies.

Trust preferred securities are dated cumulative preferred securities issued out of a special purpose entity, usually in the form of a trust, in which a parent owns all of the common securities. The trust's sole asset is a deeply subordinated note issued by the parent. The subordinated note, which is senior only to the Parent's common and preferred stock, has terms that generally mirror those of the trust preferred securities.

The terms of the trust preferred securities allow dividends to be deferred for at least a 20 consecutive quarter period without creating an event of default or acceleration. After the deferral of dividends for this 20 quarter period, if the Parent fails to pay the cumulative dividend amount owed to investors, an event of default and acceleration occurs, giving investors the right to acquire the subordinated note issued by the Parent. At the same time, the Parent's obligation to pay principal and interest on the underlying junior subordinated note accelerates and the note becomes immediately due and payable.

A key advantage of trust preferred securities to the Parent is that for tax purposes the dividends paid on trust preferred securities, unlike those paid on directly issued preferred stock, are a tax deductible interest expense. The IRS ignores the trust and focuses on the interest payments on the underlying subordinated note.

Trust Preferred Securities receive limited equity credit from the rating agencies (Moody's: 0%; S&P: 40% (corporates) and 100% (financials)).

Perpetual preferred stock has no fixed maturity date and cannot be redeemed at the option of the holder. Perpetual preferred stock, with certain features, can obtain high equity credit (Moody's: 75-100%; S&P: up to 60% (corporates) and 100% (financials)) but is more expensive capital since it is not tax deductible—dividends are paid out of after tax earnings and profits.

Hybrid securities are securities that have some equity characteristics and some debt characteristics. Ratings agencies such as Moody's and Standard & Poor's have created defined “baskets” based on the “equity-like” or “debt-like” content of a security. Securities are classified into baskets meeting specific criteria, and the basket to which a security is assigned determines a specified percentage of equity treatment for which the security qualifies.

For example, Moody's has five baskets (A-E). Securities with an A basket classification are treated as 0% equity and 100% debt. At the other extreme, securities with an E basket classification are treated as 100% equity and 0% debt. The A basket includes dated subordinated debt (with maturity of less than 49 years). The E basket encompasses instruments having five characteristics: mandatory convertible; convertible within three years; subordinated debt, preferred or senior, with accelerated conversion; optional deferral; and cumulative coupon.

In order to assign a hybrid security to a basket, Moody's assesses the instrument's equity-like characteristics. In particular, securities with the following features will be classified as Basket C securities (treated as 50% equity and 50% debt): (a) preferred; (b) perpetual or long-dated; (c) typically non-call 5 or 10 years; (d) optional deferral; (e) non-cumulative dividends; and (f) replacement language required. Securities classified as Basket D (75% equity and 25% debt) have many of the same features as Basket C securities, the main differences being that the Basket D securities must be perpetual (or long-dated with a capital replacement requirement) and deferral must be mandatory (not optional).

One embodiment of the present invention provides many of the advantages of the two products described above, while avoiding many of the disadvantages. The embodiment provides securities (enhanced capital advantaged preferred securities (“ECAPS”) that are tax-deductible yet also receive equity credit similar to that of perpetual preferred stock. This preferably is accomplished by: (1) the trust issuing 60-year securities to investors, alternatively the LLC and the trust can be eliminated and the Parent can directly issue 60-year securities to investors; (2) an optional and mandatory deferral feature is added to ensure high equity content; (3) a required sale of common or preferred stock to pay distributions after 20 periods of optional deferral or immediately upon occurrence of mandatory deferral to allow preservation of existing cash for creditors, while paying distributions as required for tax purposes; (4) a parent creating an LLC and a trust contributing capital to the LLC; (5) the LLC making a deeply subordinated dated loan (30+ years) back to the company; (6) at maturity of the initial loan, the LLC will likely reinvest in similar deeply subordinated loans of the parent or affiliates.

Another embodiment comprises a “convertible version” of the embodiment described above. In this embodiment (referred to herein as Deductible Preferred Income Equity Replacement Shares, or “Deductible PIERS”), high equity content and tax deductibility are maintained while a net share settlement conversion option is provided to reduce cash interest expense.

Deductible PIERS are accounted for on a net share settlement basis, using a method similar to treasury stock accounting. Deductible PIERS achieve this accounting treatment by being convertible into a non-convertible preferred stock with the same or lower dividend rate as the interest rate on the Deductible PIERS at any time at the option of the holder, plus common stock for the in-the-money amount. The non-convertible preferred stock received upon conversion is mandatorily redeemable upon any redemption of the Deductible PIERS. This structure balances accounting and rating agency concerns by limiting any delivery of cash to the control of the issuer, and in all cases only delivering common stock with respect to the in-the-money amount, while achieving tax efficiency through the contingent debt deductions and reducing the cash interest expense.

In one aspect, the invention comprises a security that: (a) is tax deductible; (b) receives equity credit of 40-75% from Moody's and S&P; and (c) qualifies for net share settled accounting.

In various embodiments: (1) the security is a preferred income equity replacement security; (2) the security has a final maturity of 60 years or more; (3) the security has a scheduled maturity of 30 years or more; (4) the security is subordinated to all senior and subordinated debt of an issuer of the security but is not subordinated to claims of trade creditors; (5) after a first period of time or after a mandatory trigger event, an issuer of the security is required to sell stock or warrants, subject to a preferred stock cap and a warrant cap, to pay interest on the security; (6) a mandatory trigger event is defined to include a leverage ratio exceeding a threshold for a second period of time; (7) a mandatory trigger event is defined to include an interest coverage ratio being less than a threshold for a third period of time; (8) the security has a contingent interest feature; (9) holders of the security have a right, at any time prior to the scheduled maturity date, to convert the security for shares of perpetual preferred stock issued by an issuer of the security and a number of shares of common stock if a product of an applicable stock price and a conversion rate exceeds a liquidation preference amount of the perpetual preferred stock, wherein the number of shares of common stock is based on a formula comprising the applicable stock price, the conversion rate, and the liquidation preference amount; (10) upon conversion, holders of the security receive, for each principal amount of the security, a liquidation preference amount of perpetual preferred stock, on the condition that upon conversion following the occurrence of an event, the holders receive cash in lieu of the liquidation preference amount of perpetual preferred stock; (11) the event comprises a notice of redemption of the security; (12) the perpetual preferred stock has one or more of the following characteristics: (a) a cumulative dividend rate equal to or less than the interest rate paid on the security; (b) mandatory deferral provisions corresponding to mandatory deferral provisions of the security; (c) deferred interest on the security is payable on the perpetual preferred stock; (d) redeemable in cash at a price equal to a liquidation preference; (e) must be redeemed on a date following an optional redemption date of the security; and (f) a capital replacement intention corresponding to a capital replacement intention of the security.

In one aspect, the invention comprises a method comprising: (a) structuring a convertible security to be tax deductible; (b) structuring the convertible security to receive equity credit of 40-75% from Moody's and S&P; (c) structuring the convertible security to qualify for net share settled accounting; and (d) issuing the security.

In various embodiments: (1) the method further comprises structuring the security as a preferred income equity replacement security; (2) the method further comprises structuring the security to have a final maturity of 60 years or more; (3) the method further comprises structuring the security to have a scheduled maturity of 30 years or more; (4) the security is subordinated to all senior and subordinated debt of an issuer of the security but is not subordinated to claims of trade creditors; (5) after a first period of time or after a mandatory trigger event, an issuer of the security is required to sell stock or warrants, subject to a preferred stock cap and a warrant cap, to pay interest on the security; (6) a mandatory trigger event is defined to include a leverage ratio exceeding a threshold for a second period of time; (7) a mandatory trigger event is defined to include an interest coverage ratio being less than a threshold for a third period of time; (8) the security has a contingent interest feature; (9) holders of the security have a right, at any time prior to the scheduled maturity date, to convert the security for shares of perpetual preferred stock issued by an issuer of the security and a number of shares of common stock if a product of an applicable stock price and a conversion rate exceeds a liquidation preference amount of the perpetual preferred stock, wherein the number of shares of common stock is based on a formula comprising the applicable stock price, the conversion rate, and the liquidation preference amount; (10) upon conversion, holders of the security receive, for each principal amount of the security, a liquidation preference amount of perpetual preferred stock, on the condition that upon conversion following the occurrence of an event, the holders receive cash in lieu of the liquidation preference amount of perpetual preferred stock; (11) the event comprises a notice of redemption of the security; (12) the perpetual preferred stock has one or more of the following characteristics: (a) a cumulative dividend rate equal to or less than the interest rate paid on the security; (b) mandatory deferral provisions corresponding to mandatory deferral provisions of the security; (c) deferred interest on the security is payable on the perpetual preferred stock; (d) redeemable in cash at a price equal to a liquidation preference; (e) must be redeemed on a specified date following an optional redemption date of the security; and (f) a capital replacement intention corresponding to a capital replacement intention of the security.

In another aspect, the invention comprises a method comprising: (a) purchasing a security with a scheduled maturity date of 30 years or more; (b) redeeming the security prior to the maturity date for a first number of shares of perpetual preferred stock and a second number of shares of common stock; and (c) receiving cash in lieu of the first number of shares of perpetual preferred stock.

In various embodiments: (1) the security: (a) is tax deductible; (b) receives equity credit of 40-75% from Moody's and S&P; and (c) qualifies for net share settled accounting; (2) the security is a preferred income equity replacement security; (3) the security has a final maturity of 60 years or more; (4) the security is subordinated to all senior and subordinated debt of an issuer of the security but is not subordinated to claims of trade creditors; (5) after a first period of time or after a mandatory trigger event, an issuer of the security is required to sell stock or warrants, subject to a preferred stock cap and a warrant cap, to pay interest on the security; (6) a mandatory trigger event is defined to include a leverage ratio exceeding a threshold for a second period of time; (7) a mandatory trigger event is defined to include an interest coverage ratio being less than a threshold for a third period of time; (8) the security has a contingent interest feature; (9) holders of the security have a right, at any time prior to the scheduled maturity date, to convert the security for shares of perpetual preferred stock issued by an issuer of the security and a number of shares of common stock if a product of an applicable stock price and a conversion rate exceeds a liquidation preference amount of the perpetual preferred stock, wherein the number of shares of common stock is based on a formula comprising the applicable stock price, the conversion rate, and the liquidation preference amount; (10) upon conversion, holders of the security receive, for each principal amount of the security, a liquidation preference amount of perpetual preferred stock, on the condition that upon conversion following the occurrence of an event, the holders receive cash in lieu of the liquidation preference amount of perpetual preferred stock; (11) the event comprises a notice of redemption of the security; (12) the perpetual preferred stock has one or more of the following characteristics: (a) a cumulative dividend rate equal to or less than the interest rate paid on the security; (b) mandatory deferral provisions corresponding to mandatory deferral provisions of the security; (c) deferred interest on the security is payable on the perpetual preferred stock; (d) redeemable in cash at a price equal to a liquidation preference; (e) must be redeemed on a date following an optional redemption date of the security; and (f) a capital replacement intention corresponding to a capital replacement intention of the security.

Embodiments of the present invention preferably comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

In one aspect, the invention comprises a computer based method comprising: (a) forming a trust operable to issue trust preferred securities over the computer network; and (b) electronically issuing over the computer network subordinated notes with at least a 30-year maturity to the trust.

In another aspect, the invention comprises a method comprising: the parent directly issuing subordinates notes to investors.

In various embodiments: (1) the subordinated notes have a maturity of at least 30 years; (2) the trust preferred securities are 60-year dated preferred securities; (3) the method further comprises guaranteeing the subordinated notes; and (4) the trust is covered by a support agreement that ensures that it will have enough assets to pay its obligations.

In another aspect, the invention comprises a method comprising: (a) forming a trust operable to issue trust preferred securities; and (b) receiving subordinated notes with a maturity of at least 30 years from a parent in exchange for a loan to the parent.

In various embodiments: (1) the subordinated notes have a deferral period of 10 years; (2) after a predetermined period of optional deferral, the parent is obligated to sell warrants or common or preferred stock in order to fund distribution payments; (3) the predetermined period is five years; (4) upon mandatory deferral, the parent is obligated to issue warrants or common or preferred stock in order to fund distribution payments; (5) after 10 years of deferral, holders of the subordinated notes have a right to accelerate the loan and the notes become immediately due and payable.

In another aspect, the invention comprises a security that: (a) is tax deductible, and (b) receives equity credit above 50% from Moody's and S&P.

In various embodiments: (1) the equity credit is similar to that of perpetual preferred stock; (2) the security is a preferred security issued by a trust, wherein the trust is operable to purchase subordinated notes from a parent with funds received from the trust in exchange for the trust preferred securities; (3) the security is a 60-year dated preferred security; (4) the subordinated notes are guaranteed by the parent; and (5) the trust is covered by a support agreement that ensures that it will have enough assets to pay its obligations.

### BRIEF DESCRIPTION OF THE DRAWINGS

FIG. 1 illustrates an ECAPS structure.

FIG. 2 depicts flow for cash and securities.

FIG. 3 depicts an embodiment, with a foreign parent.

FIG. 4 depicts ECAPS embodiments.

FIG. 5 depicts a structure for Deductible PIERS.

### DETAILED DESCRIPTION OF EMBODIMENTS

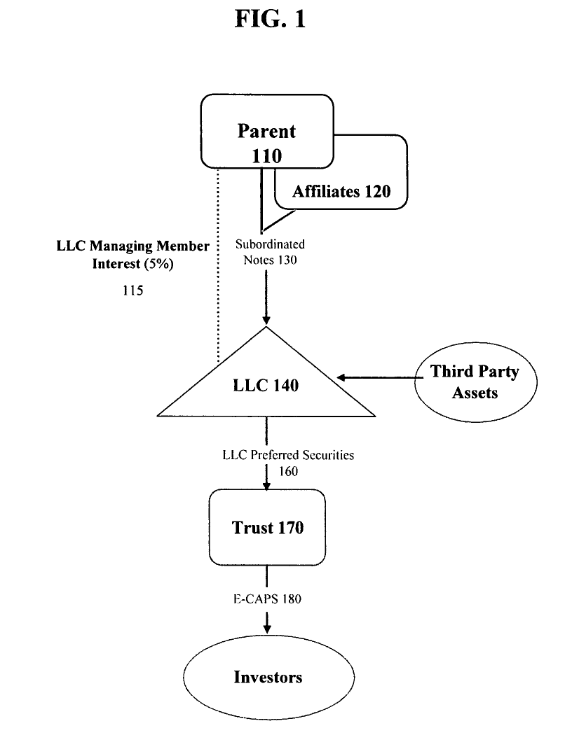

In one embodiment, referring to FIG. 1, Parent 110 forms Limited Liability Company (LLC) 140 and contributes minimal proceeds 115 equal to 0-5% of total capital (including LLC preferred) for the managing member interest. Parent also causes a Delaware Trust 170 to be formed. Parent owns all of the common securities of the LLC and the Trust.

Trust 170 issues 60-year preferred securities with capital replacement language—ECAPS 180- to investors and purchases mirror LLC preferred securities 160.

LLC will on-loan to Parent 110 the proceeds from the ECAPS offering in the form of subordinated notes 130 with a 30-year maturity. That is, the Parent issues the notes to the LLC and pays interest on the notes to the LLC. Interest payments on the subordinated notes 130 will fund distribution payments for ECAPS 180. The Parent preferably guarantees the trust preferred securities and, of course, the subordinated notes. These guarantees will be recognized by those skilled in the art as required under the Securities Act of 1940.

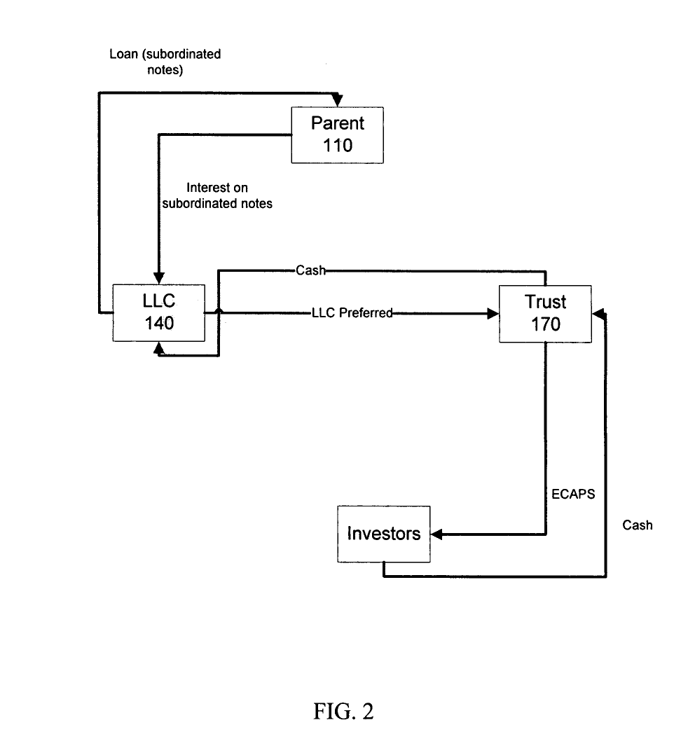

FIG. 2 depicts flow of cash and securities between the various entities.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; Affiliate loans may be guaranteed by Parent.

These ECAPS preferably have “enhanced equity credit” features: (1) long-dated maturity—60 years; (2) cumulative distributions with a “mandatory deferral” of distributions upon breach of trigger; and (3) capital replacement “intent” language. “Tax deductible features” comprise: (1) ultimately on-loan to Parent of dated subordinated note; (2) the holders of the ECAPS right to liquidate the LLC and claim the subordinated note after deferral of distributions for 7 years, and ultimately accelerate the notes after a maximum of 12 years aggregate deferral; (3) creating a wholly-owned LLC subsidiary that allows reinvestment in dated subordinated notes; (4) parent issues 30-year subordinated notes to LLC in exchange for preferred proceeds; and (5) required investment of LLC assets in subordinated or third-party assets at maturity.

ECAPS are expected to achieve the same rating agency benefit as directly issued high equity content preferred stock, while achieving better cost efficiency due to tax-deductible distributions.

ECAPS Compared to Trust Preferred

Issuer: The issuer for trust preferred is typically a Delaware business trust owned by a parent. The issuer for ECAPS is preferably a Delaware business owned by a parent that invests in LLC preferred.

Taxation: The trust for trust preferred is treated as a grantor trust, and thus ignored for tax purposes. The same applies to the ECAPS trust; the LLC is treated as a partnership for tax purposes.

Accounting: A trust-preferred trust is deconsolidated under FIN 46, and the junior subordinated debt appears as equity on the balance sheet. For ECAPS, both the LLC and the trust will be deconsolidated under FIN 46, and the junior subordinated debt will appear as equity on the balance sheet.

Maturity: Maturity for trust preferred is 30-49 years; for ECAPS, 60 years.

Assets of issuer: For trust preferred, assets are the junior subordinated debt of parent 110. There is no reinvestment. For ECAPS, assets are the junior subordinated debt of the parent 110 and affiliates 120, and a small percentage (1-5%) of assets may be invested in eligible third party assets 150. At maturity of the debt, LLC 140 must reinvest in similar debt of parent 110 and affiliates 120.

Payments: For trust preferred, payments are cumulative, and deferrable for 5 years at issuer's option. All deferred payments must be repaid at the end of the 5 years. For ECAPS, payments are deferrable for 5 years at issuer's option, but deferred payments do not need to be repaid until the ECAPS are redeemed. Moreover, payments are mandatorily deferrable if certain financial metrics are breached: upon a breach of “mandatory deferral trigger” or optional deferral for 5 years, the parent 110 must use commercially reasonable efforts to issue preferred or common stock to fund distributions.

Subordination: Trust preferred is subordinated to senior and subordinated debt holders. ECAPS are subordinated to senior, subordinated debt, trust preferred.

ECAPS Equity Content

Feature 1: No or Long-dated Maturity. ECAPS have 60-year maturity with a capital replacement feature. This results in a Moody's equity content scoring of “moderate.”

Feature 2: No Ongoing Payments. ECAPS have optional deferral of subordinated notes interest up to 5 years, and a mandatory deferral of preferred dividends upon breach of a trigger. In the event of a mandatory deferral or optional deferral of more than 5 years (20 quarters) the Parent must use commercially reasonable efforts to issue common or preferred stock to fund distributions due on ECAPS. This results in a Moody's equity content scoring of “strong.”

Feature 3: Loss Absorption. ECAPS are junior to all creditors and thus provide a loss-absorbing cushion. This results in a Moody's equity content scoring of “moderate/strong.”

Based on the above scoring, ECAPS will receive the same treatment as Basket D Preferred Stock.

Tax Treatment

ECAPS will be treated as partnership interests in LLC 140. Parent 110 and its operating subsidiaries will be entitled to deductions on interest payments made on the Subordinated Notes held by LLC 140. ECAPS holders will be allocated interest income equal to the distribution rate on Preferred Securities 160.

Accounting

LLC 140 will be deconsolidated under FIN 46. On a consolidated basis, parent 110 issues 30-year subordinated debt.

Corporate

LLC 140 and trust 170 will be need to added to parent 110's shelf in order to do a registered transaction. Alternatively, ECAPS can be sold as 144A.

Example term sheets (“indicative terms and conditions) for ECAPS are provided below in the Appendices.

In an alternate embodiment, and referring again to FIG. 1, Trust 170 issues perpetual preferred securities with capital replacement language—ECAPS 180—to investors and purchases mirror LLC preferred securities 160.

LLC will on-loan to Parent 110 and at least 2 Affiliates 120 (e.g., 80% to Parent 110, 20% to Affiliates 120) the proceeds from the ECAPS offering in the form of subordinated notes 130 with a 30-year maturity. Affiliate loans may be guaranteed by Parent 110. Interest payments on the subordinated notes 130 will fund distribution payments for ECAPS 180.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; or (b) short-term, high quality third party assets 150.

These ECAPS preferably have “enhanced preferred stock” features: (1) long-dated; (2) cumulative dividends with mandatory deferral of distributions upon breach of trigger; and (3) capital replacement “intent” language. “Tax deductible features” comprise: (1) wholly-owned LLC subsidiary issues preferred securities; (2) parent issues 30-year subordinated notes to LLC in exchange for preferred proceeds; (3) 5% of LLC assets must be invested in third-party assets; and (4) required investment of LLC assets in subordinated or third-party assets at maturity.

In another embodiment, the company forms a Trust and on-loans proceeds to the Parent in the form of a 60-year subordinated loan. The Subordinated Note will have same level of subordination as the note in the LLC structure.

In addition, the Subordinated note will have deferral for 10 to 12 years. After 5 years of optional deferral, the Parent is required to sell common or preferred stock to fund distribution payments. Upon mandatory deferral, the Parent is immediately required to issue common or preferred stock to fund distribution payments. After 10 to 12 years of deferral, the holders of the Note have the right to accelerate the loan and the note becomes immediately due and payable.

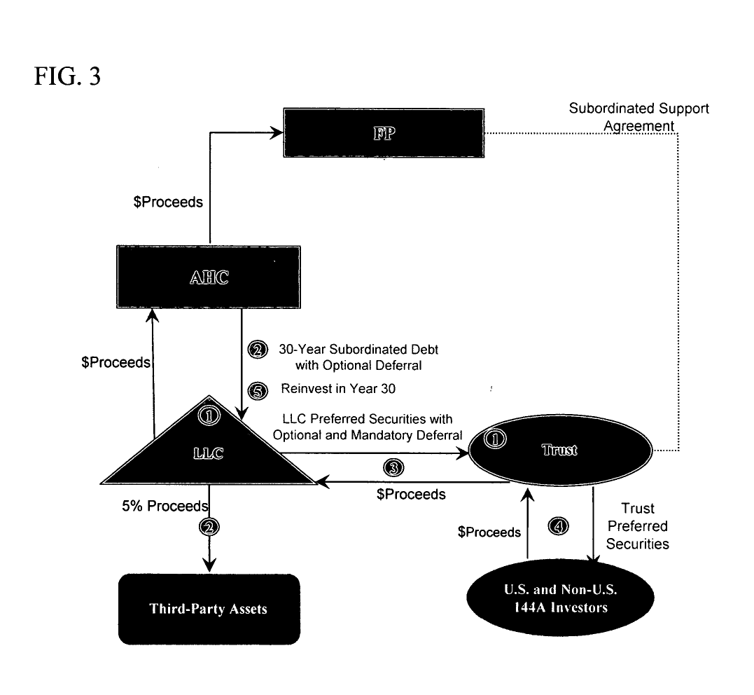

In another embodiment, the Parent may be a non-U.S. company. In that case, a more complicated arrangement may be used to obtain the tax benefits of ECAPS. For example, as depicted in FIG. 3, the Foreign Parent FP may own an American Holding Company AHC. Also formed are an LLC and a Trust.

(1) AHC Organizes LLC and Trust

Preferably, the AHC organizes LLC and in exchange for a Managing Member Interest. The AHC also organizes Trust.

(2) AHC Issues Subordinated Notes to LLC

The LLC invests in 30-year subordinated debt of AHC with a 5-year optional deferral provision. The LLC also invests 1-5% of the proceeds in high quality, short-term third party assets (e.g., A-1/P-1 CP paper).

(3) LLC Issues Preferred Securities to Trust

The Trust invests in 60-year preferred securities of the LLC with an optional deferral provision and mandatory deferral trigger event (“MDTE”). If the MDTE is breached by FP, distributions on the LLC preferred securities may only be paid from amounts received as a capital contribution from FP, the proceeds of which are raised from a sale of FP common stock. During a MDTE, payments will either be made or accrue on the AHC subordinated debt. Payments will accrue and not be made if AHC elects to utilize the optional deferral provision on the underlying subordinated debt. If payments are missed on the LLC preferred securities for a period exceeding 7 years, the LLC may be dissolved and the Trust will directly own each underlying AHC subordinated debt. If the 5-year deferral option on the subordinated debt has not been previously utilized, the 5 years of deferral is still available after liquidation of the LLC.

(4) Trust Issues Trust Preferred Securities to U.S. and Non-U.S. 144A Investors

The Trust will benefit from a subordinated Support Agreement from FP. Terms of the trust preferred securities may comprise: (a) redeemable in Year 5 (Series I) or Year 10 (Series II); and (b) redemption is subject to capital replacement intent language.

(5) Reinvestment of Subordinated Notes at Maturity

At maturity of the initial AHC subordinated debt investment in Year 30, the LLC may reinvest the proceeds at an arms-length rate in two new 30-year subordinated debts of any qualifying affiliate except for AHC. Following a reinvestment of subordinated debt of an affiliate, the affiliate debt will be rated at a minimum equal to the ratings of the ECAPS immediately prior. If reinvestment occurs in Year 30, any incremental return from a rate increase (above the stated rate) will be paid 50% to the investors of LLC preferred securities and 50% to AHC as the Managing Member.

More details regarding an exemplary structure and method of this embodiment may be found in Appendix B.

Thus, in contrast to the previously described embodiments, in this embodiment the borrower on the subordinated notes is not the foreign parent (FP), but instead the U.S. subsidiary (AHC). AHC preferably also is the owner of the common securities of the Trust and the LLC. This structure allows AHC to obtain the same tax benefits as Parent in the other embodiments. However, FP is the entity on which investors rely on the credit of the group. Consequently, FP is subject to a Support Agreement (see Appendix B) that obligates FP to ensure that the Trust and the LLC have sufficient assets to meet their obligations.

Deductible PIERS

Another embodiment (“Deductible PIERS”) of the invention preferably has one or more of the following features. Those skilled in the art will recognize that many of these features may be varied without departing from the spirit and scope of the present invention.

(1) Securities Offered: Premium Equity Replacement Securities (PIERS), with a principal amount of $1,000 per PIERS.

(2) Ranking: Subordinated to all senior and subordinated debt of the Issuer but not to claims of trade creditors.

(3) Final Maturity: 60 years.

(4) Scheduled Maturity: 30-40 years. The Issuer preferably is obligated to use commercially reasonable efforts to raise sufficient net proceeds from the sale of qualifying capital securities to repay the PIERS in full. Failure to repay the PIERS will be a breach of covenant, but not an event of default, and the Issuer will have an ongoing obligation to repay the PIERS with the proceeds of qualifying capital securities on each succeeding interest payment date.

(5) Interest Rate: To be determined (TBD), preferably payable semi-annually in arrears, unless deferred as discussed below under “Deferral of Interest.” Upon any deferral of interest, the Issuer will not be permitted to make payments on or repurchase any of its common stock, preferred stock, or debt securities, or guarantees having the same rank as or ranking junior to the PIERS. Following the Scheduled Maturity Date, the interest rate for the PIERS will be reset to LIBOR plus [TBD]% (preferably the comparable Issuer floating debt rate at issue plus 100 basis points)

(6) Deferral of Interest: Interest on the PIERS may be optionally deferred for up to 10 years. If a Mandatory Trigger Event occurs, the Issuer may not pay interest on the PIERS except out of proceeds from the sale of common stock, warrants or preferred stock as described below. Interest will continue to accrue on the PIERS during a deferral period at the same rate, compounded semi-annually.

After five years of optional deferral or upon the occurrence of any Mandatory Trigger Event (discussed below), the Issuer is required, absent a market disruption event, to sell common stock or net share settled warrants with a strike price premium or qualifying preferred stock limited to no more than 25% of the aggregate initial principal amount of the PIERS (the “Preferred Stock Cap”). Notwithstanding the foregoing, in no event will the Issuer be required to sell common stock or warrants to the extent the number of underlying shares would a predetermined specified number (the “Warrant Cap”). Any failure by the Issuer to sell common stock, warrants and/or preferred stock when required, other than as a result of a market disruption event, the Warrant Cap, or the Preferred Stock Cap, shall be a breach of covenant under the indenture, but it will not constitute an event of default thereunder.

The Issuer may covenant in the indenture for the PIERS that following the required sale of warrants or preferred stock upon the occurrence of a Mandatory Trigger Event, the Issuer will not repurchase any of those warrants or any common stock or preferred stock until one year following the final date on which any such warrants or preferred stock are sold.

All deferred interest, including interest thereon, must be paid no later than the tenth anniversary of the beginning of the deferral period. If there is a failure to pay interest beyond the 10th anniversary of the commencement of any deferral period, or the Issuer otherwise fails to pay principal when required, the holders may accelerate the principal of the PIERS or otherwise enforce their creditors' rights.

Upon any bankruptcy of the Issuer, claims in respect of any interest accrued on the PIERS that is unpaid as a consequence of a Mandatory Trigger Event that had persisted in excess of two years at the time of such accrual (including compounded interest thereon) will be extinguished.

(7) Mandatory Trigger Event: A Mandatory Trigger Event will have occurred with respect to any interest period if on the 30th day prior to the interest payment date for such period:
The Leverage Ratio is equal to or greater than [a first specified threshold] for each of the three most recently completed fiscal quarters; and
The Interest Coverage Ratio is equal to or less than [a second specified threshold] for each of the three most recently completed fiscal quarters.

(8) Contingent Interest: The PIERS may have a feature such that beginning with the semi-annual interest period commencing on the [3rd/5th] anniversary of the issuance of the PIERS, and ending with the last semi-annual interest period beginning prior to the 30th Anniversary, if the trading price of the PIERS for each of the five trading days ending on the second trading day immediately preceding the first day of the applicable semi-annual interest period exceeds 125% of the principal amount of the PIERS for that semi-annual interest period, then the interest rate on the PIERS will increase by an amount equal to 25 bps multiplied by the average trading price of $1,000 principal amount of PIERS during the five trading days immediately preceding the first day of the applicable semi-annual interest period.

(9) Optional Redemption: The Issuer may redeem the PIERS at par, plus all accrued and unpaid interest, including any deferred interest, upon not less than 30 days' nor more than 60 days' notice only under the following circumstances:
(a) beginning [three/five] years from the issue date, at any time following any period of 20 trading days within any period of 30 consecutive trading days where the closing price of Issuer common shares on the New York Stock Exchange or any other nationally recognized securities exchange exceeds a specified percentage (e.g. 130%) of the then prevailing Conversion Price; or
(b) at any time beginning 30 years from the issue date;

provided that the Issuer may not redeem the PIERS while there is any unpaid deferred interest.

(10) Capital Replacement Upon Optional Redemption: Prior to any optional redemption of the PIERS and/or perpetual preferred stock prior to the Scheduled Maturity Date, the Issuer intends to sell securities with equal or greater equity credit in the aggregate than the PIERS or perpetual preferred stock, as the case may be.

(11) Capital Replacement Upon Scheduled Maturity: From and after the Scheduled Maturity Date, the Issuer may only repay the PIERS and/or perpetual preferred stock with the proceeds from the sale of qualifying capital securities as described in the Capital Replacement Covenant.

(12) Capital Replacement Covenant: The Issuer preferably will agree in a covenant for the benefit of holders of specified indebtedness that the PIERS and the perpetual preferred stock issuable upon conversion of the PIERS may only be redeemed, repaid, or repurchased from and after the Scheduled Maturity Date and prior to the 40th anniversary of the issuance of the PIERS with proceeds from the issuance of a qualifying capital security with equal or greater equity content than the PIERS and perpetual preferred stock, as the case may be.

(13) Events of Default: It preferably will be an event of default, and holders of PIERS will have the right to accelerate the principal thereof, if any of the following occur:
Default in payment of principal when due;
Default in payment of interest, including compounded interest, in full for a period of 30 days following the conclusion of a 10-year deferral period; or
Certain (specified) events of bankruptcy, insolvency and reorganization involving the Issuer.

(14) Conversion Right: Preferably, at any time prior to the 30th anniversary of the issuance of the PIERS, unless earlier redeemed, the holders of PIERS shall have the right to convert the PIERS into shares of perpetual preferred stock issued by Issuer and, if applicable, shares of Issuer common stock.

The PIERS will be convertible based on an initial conversion rate of [ ] shares of Issuer common stock for each $1,000 in principal amount of PIERS (equivalent to an initial conversion price of approximately $[ ] per share of Issuer common stock), subject to customary anti-dilution adjustments. Upon conversion, holders of PIERS will receive for each $1,000 principal amount of PIERS:
(A) $1,000 liquidation preference of perpetual preferred stock issued by the Issuer with the terms described below under “Preferred Stock” or Depositary Shares representing the right to receive such perpetual preferred stock, provided that upon any conversion following a notice of redemption of the PIERS, holders shall receive $1,000 cash in lieu of perpetual preferred stock; and
(B) if the product of the applicable stock price and the conversion rate then in effect exceeds $1,000, a number of shares of Issuer common stock equal to (i) (a) the conversion rate then in effect multiplied by (b) the applicable stock price, (c) minus $1,000, divided by (ii) the applicable stock price.

The “applicable stock price” means the average closing sale price of a share of Issuer common stock over the 20 trading-day period (the “stock settlement averaging period”) beginning on the trading day immediately following the conversion date.

The settlement date will occur 23 trading days after the conversion date.

(15) Preferred Stock: Upon any applicable conversion of PIERS, the perpetual preferred stock received by holders will have the following terms:
(A) a cumulative dividend rate equal to [x % of] the interest rate of the PIERS (including the interest rate increase in year 30), with the same mandatory deferral provisions and obligation to sell [common stock,] warrants and/or preferred stock;
(B) any deferred interest on the PIERS will be payable on the perpetual preferred stock, subject to the right to continue the deferral;
(C) redeemable in cash at a price equal to the liquidation preference at any time and upon any optional redemption of the PIERS, the perpetual preferred stock must be redeemed on the date 30 calendar days following any optional redemption date for the PIERS; and
(D) the same capital replacement intention as the PIERS.

(16) Remarketing of Perpetual Preferred Stock: Unless the perpetual preferred stock has been previously redeemed or called for redemption, holders may elect, following an Issuer change of control, to have their perpetual preferred stock placed by a placement agent with the following terms:
(A) a dividend rate that will be reset to the rate determined by the placement agent as the rate necessary for the perpetual preferred stock to have a market value at least equal to the liquidation preference plus the placement agent fee, with no dividend reset provision (the dividend rate may be either fixed or a LIBOR-based floating rate at the option of the Issuer); and
(B) optional redemption provisions specified by the Issuer prior to the date of the placement.

Any perpetual preferred stock that is not remarketed also will receive the reset rate. Except as set forth above, the terms of the perpetual preferred stock will remain the same following the placement.

If the placement agent cannot place the remarketed preferred security at a price of $1,000 plus accrued and unpaid dividends to the placement date prior to the 40th business day following the event triggering the remarketing, a “failed placement” will be deemed to occur.

Upon a failed placement, investors who have elected to place their perpetual preferred stock will retain such stock and the dividend rate on all perpetual preferred stock (whether or not the holder elected to remarket) will be reset and the perpetual preferred stock will be redeemable at any time by the Issuer. The reset rate will equal LIBOR plus [ ] bps (the “Stated Spread”) [equivalent to the spread over LIBOR at issue of the Issuer comparable floating rate yield at issue plus 100 bps].

(17) Change of Control Make-whole: If a change of control of Issuer occurs in which 10% or more of the consideration received by holders consists of anything other than common stock listed on a U.S. national securities exchange, the conversion rate of the PIERS converted in connection with such change of control will increase pursuant to a table of predetermined values (“change of control make whole”), with a minimum value of $1,000, as is customary for a convertible security. All of the other debt instruments of the Issuer outstanding that are senior to the PIERS have provisions that allow the holders thereof to require repayment upon any change of control.

(18) Increase in Conversion Rate: After the [3/5th] anniversary and prior to the Scheduled Maturity Date, if for 20 trading days (whether or not consecutive) in the period of 30 consecutive trading days ending on the last trading day of a fiscal quarter of the Issuer, the closing price of the Issuer common stock on the New York Stock Exchange or any other nationally recognized exchange exceeds [200%] of the then prevailing Conversion Price, then beginning with the first day of the next fiscal quarter (and only for such fiscal quarter), the conversion rate on the PIERS will increase at a specified per annum rate equal to the comparable yield at issue plus 100 basis points, with such increase to take effect, unless the PIERS have previously been redeemed, on the last day of such fiscal quarter.

High equity credit: The long-dated (preferably 60 year) maturity, along with the equity capital replacement language (“intent” or “binding”), and the optional and/or mandatory deferral provisions, result in high equity credit: 50-75% from Moody's (Basket C or D, depending on features), and 40-60% from S&P (intermediate equity credit).

Tax efficient: The junior subordinated debt structure makes the PIERS tax-deductible securities, and tax benefits can be further enhanced with the contingent interest feature, creating a CPDI (contingent payment debt instrument) security.

EPS (earnings per share) efficient: The PIERS are callable only when in the money, and upon call, the issuer delivers cash for par value and shares for in-the-money value. Also, upon early conversion, non-convertible perpetual preferred stock is delivered in lieu of cash at the same dividend rate as the PIERS. This structure qualifies for net share settled accounting: no shares are in the diluted share count until the security is in the money, and only net shares are issued at conversion.

Lower cost of financing: The conversion option allows the issuer to achieve lower coupon payments as compared to straight preferred or even ECAPS. This results in a lower cash cost and higher premiums than other high equity content derivatives.

One embodiment may achieve a Moody's Basket C equity credit rating by having the following features: (1) 60 year maturity; (2) cumulative interest; (3) binding equity capital replacement; (4) optional deferral; (5) junior subordinated debt on balance sheet; and (6) fully deductible coupon. With respect to the Moody's criteria of no maturity, ongoing payments, and loss absorption, this embodiment of Deductible PIERS is strong, weak, and moderate, respectively. An S&P rating of 40-60% equity credit for non-financials is expected.

One embodiment may achieve a Moody's Basket D equity credit rating by having the following features: (1) 60 year maturity; (2) cumulative interest; (3) equity capital replacement intent; (4) mandatory deferral trigger; (5) junior subordinated debt on balance sheet; and (6) fully deductible coupon. With respect to the Moody's criteria of no maturity, ongoing payments, and loss absorption, this embodiment of Deductible PIERS is moderate, strong, and moderate, respectively. An S&P rating of 40-60% equity credit for non-financials is expected.

Appendix C provides an exemplary term sheet for an embodiment of Deductible PIERS.

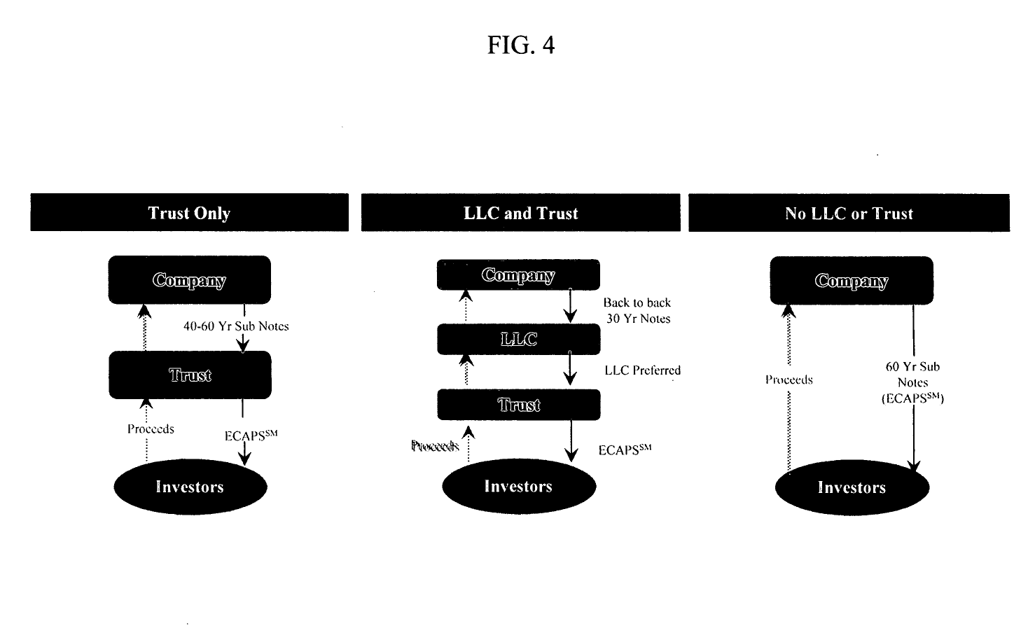

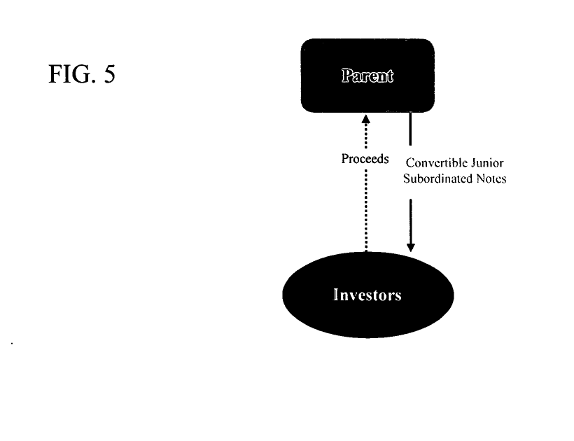

Note that the structure shown in FIG. 5 and described above is not essential to the invention. The same structures used in various ECAPS embodiments (see FIG. 4) can be used for Deductible PIERS.

While particular elements, embodiments, and applications of the present invention have been shown and described, it should be understood that the invention is not limited thereto, since modifications may be made by those skilled in the art, particularly in light of the foregoing teaching. The appended claims are intended to cover all such modifications that come within the spirit and scope of the invention.

### Appendix A

### Enhanced Capital Advantaged Preferred Securities (ECAPS^{SM})

### Summary Terms & Conditions

Issuer A Trust organized by a Limited Liability Company (“LLC”).

Securities Offered Enhanced Capital Advantaged Preferred Securities (“ECAPS^{SM}”).

Maturity [●][●], 2067.

Assets of the Trust Preferred Securities issued by the LLC (“LLC Preferred Securities”).

Assets of the LLC On the Issue Date, the LLC will invest 95% of its available funds in the Junior Subordinated Notes of the Parent;
The remaining 5% of such funds will be invested in eligible third party assets.

Liquidation Preference $1,000 per LLC Preferred Security, plus accrued and unpaid distributions.

Optional Redemption Callable at the option of the Parent at the Liquidation Preference beginning [5] years from the Issue Date, and on each Distribution Date thereafter.

Distributions The LLC Preferred Securities will pay a fixed, floating or resettable rate (the “Initial Rate”) on every quarterly or semi-annual Distribution Date until [●];
Thereafter, the rate may reset according to different terms;
If the LLC Preferred Securities are current on all distributions (i.e., no deferred amounts), the LLC Common Securities are entitled to the remaining distributions as long as it does not reduce the Liquidation Preference of the LLC Preferred Securities;
To the extent interest is paid on the Junior Subordinated Notes but distributions on the LLC Preferred Securities are deferred, the LLC will apply the payment to purchase additional Junior Subordinated Notes of the Parent having the same terms (except the rate) as the outstanding Junior Subordinated Notes.

Distribution Date Quarterly distributions on the [●]th of [March], [June], [September] and [December], beginning on [●][●], 2005.

Deferral of Distributions Distributions on the LLC Preferred Securities can be optionally deferred for 20 quarterly distribution periods (“Optional Deferral Event). After 20 periods, the Parent will be obligated to use all reasonable efforts to issue Common Stock or Perpetual Preferred Stock and contribute proceeds to the LLC to fund distributions on the LLC Preferred Securities;
If a Mandatory Deferral Event occurs (see below), the Parent will have an immediate obligation to use all reasonable efforts to issue Common Stock or Perpetual Preferred Stock and contribute proceeds to the LLC to fund distributions on the LLC Preferred Securities;
After deferral of more than 28 periods caused by either an Optional Deferral Event or Mandatory Deferral Event, the holders of the LLC Preferred Securities will be entitled to enforce their rights under the LLC Agreement, including causing a liquidation of the LLC;
If the Mandatory Deferral Event occurs and the Parent cannot issue Common Stock or Perpetual Preferred Stock for more than 2 years, any interest accruing on the Junior Subordinated Notes after that date, in a bankruptcy or liquidation, will rank junior to any Preferred Stock claims but senior to Common Stock.

Mandatory Deferral Event [company specific]

Dividend Stopper If current and deferred distributions are not fully paid on the ECAPS^{SM}, The Parent cannot make any dividend payments on its Preferred Stock or Common Stock.

Liquidation ECAPS^{SM} will have a preference over the Common Securities of the Trust with respect to payments and in liquidation.

Income Allocation of LLC Preferred Income of the LLC (including deferred interest) will be allocated to the LLC Preferred Securities prior to allocation of LLC Common Securities;
Income will be allocated to the LLC Preferred Securities in an amount equal to distributions on the LLC Preferred Securities at the Applicable Rate;
Income received by the LLC above the Applicable Rate will be allocated to the LLC Common Securities until the LLC Common Securities have been allocated total income equal to twice the Applicable Rate since the date of issuance on a quarterly compounded basis;
Thereafter, any remaining income in excess of such amount will be allocated [50/50] to the LLC Common Securities and the LLC Preferred Securities.

Loss Allocation of LLC Preferred Losses are allocated first to the LLC Common Securities until the value of the LLC Common Securities is reduced to zero;
Losses are then allocated to the LLC Preferred Securities until the value of the LLC Preferred Securities are reduced to zero;
Any additional losses are allocated thereafter to the LLC Common Securities. Reinvestment of Assets At the initial maturity of the Junior Subordinated Notes (Year 30), the proceeds will be reinvested in new Junior Subordinated Notes of the Parent with similar terms;
After the subsequent maturity of the Junior Subordinated Notes (Year 60), the LLC will be liquidated;
To the extent interest payments are made on the Junior Subordinated Notes when distributions are deferred on LLC Preferred Securities, the proceeds will be on-loaned back to the Parent or it affiliates.

Guarantee The Parent will issue guarantees of ECAPS^{SM} and LLC Preferred Securities that qualify as unconditional guarantees for purposes of Rule 3a-5 under the 1940 Act (“non-guarantee guarantees”);
The guarantees will cover income distributions to the extent the LLC or the Trust, as applicable, has available funds to distribute, and amounts payable upon liquidation or the assets of the LLC or Trust available for distribution upon liquidation.

### Initial Junior Subordinated Notes

### Summary Terms & Conditions

Issuer The Parent

Securities Offered 30-year Junior Subordinated Notes.

Principal Amount $1000 per Note.

Maturity [●][●], 2035.

Interest Payment Date Quarterly payments on the [●]th of [February], [May], [August] and [November], beginning on [●][●], 2005.

Optional Deferral Event Interest payments on the Junior Subordinated Notes may be optionally deferred for up to 20 quarterly periods.

Optional Callable Redemption at the option of the Parent at the principal amount plus accrued and unpaid interest beginning [5] years from the Issue Date.

Dividend Stopper If interest payments are not made on the Junior Subordinated Notes, the Parent cannot make any dividend payments on its Preferred Stock or Common Stock.

Amendment The Junior Subordinated Notes may be amended with majority consent of ECAPS^{SM} holders, except that, if the amendment is related to the timeliness or amount of distributions, 100% consent of holders is required.

### Appendix B

### Exemplary Terms and Conditions of Trust Preferred Securities and LLC Preferred Securities

| | |
|---|---|
| Issuer | Trust I and II. |
| Assets of the | Preferred Securities issued by LLC I and II (“LLC Preferred Securities”). |
| Trust(s) | |
| Assets of the | LLC I and II will invest 99% of its available proceeds in two 30-Year |
| LLC(s) | Subordinated Debt issued by AHC; |
| | The remaining 1% of proceeds, contributed by AHC in exchange for the |
| | Managing Member Interests, will be invested in eligible third-party assets |
| | (see Eligible Debt Securities). |
| Securities | Series I ECAPS or Trust Preferred Securities (5-Year Initial Period); |
| Offered | Series II ECAPS or Trust Preferred Securities (10-Year Initial Period). |
| Form of | Rule 144A with no registration rights; |
| Offering | Sold to qualified institutional buyers (QIB) and institutional accredited |
| | investors (IAI) only. |
| ECAPS | November [30], 2065. |
| Maturity | |
| Liquidation | $1,000 per Trust Preferred Security and LLC Preferred Security, plus |
| Amount | accrued and unpaid distributions, tradable in minimum lots of $1,000,000. |
| Optional | Callable at the Liquidation Amount at the option of FP, in whole or in |
| Redemption | part, beginning 5 years from issuance date (Series I) or 10 years from |
| | issuance date (Series II), and on each Distribution Date thereafter; |
| | Callable at a make-whole redemption price, in whole but not in part, upon |
| | a Tax Event or Investment Company Act Event. |
| Capital | FP does not intend to redeem or cause the redemption of Trust Preferred |
| Replacement | Securities and LLC Preferred Securities unless FP or an affiliate issues a |
| Provision | security with equal or greater equity characteristics. |
| Distribution | Semiannual distributions on the [30th] day of [May] and [November] |
| Date | beginning on [May] [30], 2006. |
| Distributions | The Trust Preferred Securities and LLC Preferred Securities will pay [•] |
| | % (the “Applicable Rate”) on every semiannual Distribution Date until |
| | Year 5 (Series I) or Year 10 (Series II); |
| | Thereafter, the Applicable Rate will reset to the initial credit spread plus |
| | the highest of 3-month LIBOR, 10-year Constant Maturity Treasury or |
| | 30-year Constant Maturity Treasury (“ARP Curve”); |
| | If the Trust Preferred Securities and LLC Preferred Securities are current |
| | on all distributions (i.e., no deferred amounts), FP is entitled to the |
| | remaining distributions as long as it does not reduce the Liquidation |
| | Amount; |
| | To the extent payments are made on the Subordinated Debt of AHC but |
| | deferred on the LLC Preferred Securities, LLC I and II may apply the |
| | excess payments to purchase Subordinated Debt of AHC or other FP |
| | affiliates having the same terms as the outstanding Subordinated Debt |
| | (except for rate and call provisions). |
| Deferral of | Distributions on the Trust Preferred Securities and LLC Preferred |
| Distributions | Securities can be optionally deferred for 10 semiannual periods (an |
| | “Optional Deferral Event); |
| | After 10 periods, FP will use its commercially reasonable efforts |
| | to issue Common Stock and contribute proceeds to the LLC to |
| | fund distributions on the Trust Preferred Securities and LLC |
| | Preferred Securities |
| | If a Mandatory Deferral Trigger Event occurs, FP will use its |
| | commercially reasonable efforts to issue Common Stock immediately and |
| | contribute proceeds to the LLC to fund distributions on the Trust |
| | Preferred Securities and LLC Preferred Securities; |
| | After deferral of more than 14 semiannual periods caused by either an |
| | Optional Deferral Event or Mandatory Deferral Trigger Event, the holders |
| | of the LLC Preferred Securities will be entitled to enforce their rights |
| | under the LLC Agreement, including causing a liquidation of LLC I and |
| | II; |
| | If a Mandatory Deferral Trigger Event occurs and FP cannot issue |
| | Common Stock for more than 2 years which is not cured (e.g., Mandatory |
| | Deferral Trigger Event continues and FP cannot issue Common Stock), |
| | holders of the LLC Preferred Securities and Trust Preferred Securities will |
| | not be entitled to income allocation associated with any further accrual of |
| | interest on the Subordinated Debt upon a liquidation of LLC I and II. |
| Mandatory | LLC I and II and AHC, as the Managing Member, will be prohibited from |
| Deferral | paying distributions on Trust Preferred Securities and LLC Preferred |
| Trigger | Securities if: |
| Event | FP trailing 4 Quarters Consolidated Net Income for the most |
| | recently completed Quarter is not a positive amount; and |
| | FP Adjusted Shareholders' Equity for the most recently completed |
| | 8 Quarters has declined by greater than 10%; |
| | If both conditions are met, FP will have the ability to “cure” |
| | Adjusted Shareholders' Equity for 2 forward Quarters by issuing |
| | Common Stock to increase the Adjusted Shareholders' Equity |
| | amount above the 10% decline; |
| | Adjusted Shareholders' Equity is the Shareholders' Equity |
| | as reflected on FP's consolidated Balance Sheet as of any |
| | quarter end, minus Preferred Securities, Net Unrealized |
| | Gains and Losses on Investments, and Cumulative |
| | Translation Adjustments; |
| | If there is a change in IAS/IFRS that results in a |
| | cumulative effect of a change in accounting principle or a |
| | restatement such that the Net Income or Shareholders' |
| | Equity amounts are different than as would have been |
| | calculated absent such change, then the amounts will be |
| | calculated as if such change had not occurred. |
| Restrictions | During an Optional Deferral Event, if FP makes any distributions on its |
| on Dividends | Common or Preferred Securities, all current and deferred distributions on |
| | the Trust Preferred Securities and LLC Preferred Securities must be made; |
| | During a Mandatory Deferral Trigger Event, if current and deferred |
| | distributions are not fully paid on the Trust Preferred Securities and LLC |
| | Preferred Securities, FP management will not recommend to the Board to |
| | make any distributions on its Common or Preferred Securities. |
| Income | Income of LLC I and II (including deferred distributions) will be allocated |
| Allocation of | to the LLC Preferred Securities prior to AHC; |
| LLC | Income will be allocated to the LLC Preferred Securities in an amount |
| Preferred | equal to distributions on the LLC Preferred Securities at the Applicable |
| Securities | Rate; |
| | Income received by LLC I and II above the Applicable Rate will be |
| | allocated to AHC at a stated rate; |
| | Thereafter, any remaining income in excess of such amount will be |
| | allocated on a 50%/50% basis to AHC and the LLC Preferred Securities. |
| Loss | Losses are allocated first to AHC until the value of the Managing Member |
| Allocation of | Interests is reduced to zero; |
| LLC | Losses are then allocated to the LLC Preferred Securities until the |
| Preferred | Liquidation Amount of the LLC Preferred Securities is reduced to zero; |
| Securities | Any additional losses are allocated thereafter to AHC. |
| Eligible Debt | LLC will invest 1% of the initial proceeds in Eligible Debt Securities that |
| Securities | meet any of the following conditions: |
| | Any securities issued or guaranteed by the U.S. government; |
| | Commercial paper rated by Moody's and S&P in the highest |
| | investment grade category and maturing no later than 9 months; |
| | Demand deposits, time deposits and certificates of deposits fully |
| | insured by the FDIC; |
| | Repurchase obligations with respect to any securities issued or |
| | guaranteed by the U.S. government; |
| | Any other security that is identified as a permitted investment of a |
| | finance subsidiary under the Investment Company Act. |
| Support | FP and FH will each provide a subordinated Support Agreement to Trust I |
| Agreement | and II to ensure that Trust I and II will be in a position to meet its |
| | obligations. |

### Exemplary Terms and Conditions of Initial Subordinated Debt

| | |
|---|---|
| Issuer | AHC |
| Securities | 30-year Subordinated Debt: |
| Offered | Series I (5-Year Initial Period); |
| | Series II (10-Year Initial Period). |
| Principal | $1,000 per Security. |
| Amount | |
| Maturity | [May][30], 2035. |
| Distribution | Semiannual payments on the [30th] day of [May] and [November] |
| Date | beginning on [May][30], 2006; |
| | To the extent payments are made on the Subordinated Debt when |
| | distributions are deferred on the Trust Preferred Securities and LLC |
| | Preferred Securities, the proceeds will be on-loaned back to AHC or its |
| | affiliates. |
| Optional | Callable at the option of FP at the Principal Amount plus accrued and |
| Redemption | unpaid interest payments beginning 5 years from issuance date (Series I) |
| | or 10 years from issuance date (Series II). |
| Optional | Payments on the Subordinated Debt may be optionally deferred for up to |
| Deferral | 10 semiannual periods. |
| Event | |
| Amendment | The terms of the Subordinated Debt may be amended with the majority |
| | consent of the holders, except that, if the amendment is related to the |
| | timeliness or amount of payments, 100% consent of the holders is |
| | required. |
| Reinvestment | At the initial maturity of the Subordinated Debt in Year 30, LLC I and II |
| of | will reinvest the proceeds in two new Subordinated Debt of any affiliate |
| Subordinated | other than AHC (“Affiliate”) with similar terms; |
| Debt | LLC I and II may only reinvest the proceeds in Year 30 if the following |
| | conditions are satisfied (“Reinvestment Criteria”): |
| | The new Subordinated Debt must mature no later than 30 years |
| | from its date of issuance and no later than 60 years from the date |
| | of issuance of LLC Preferred Securities; |
| | For 3 years prior to such reinvestment, there has been no default |
| | under any mortgage, indenture or instrument related to any |
| | indebtedness issued or guaranteed by Affiliate, nor bankruptcy of |
| | such Affiliate, nor arrearages of distributions on any Preferred |
| | Securities issued by Affiliate; |
| | The terms of the new Subordinated Debt must be verified by an |
| | Independent Financial Advisor and determined to be at least as |
| | favorable as the terms that would have resulted from a public or |
| | 144A offering of a comparable security issued by Affiliate; |
| | Affiliate shall not be deemed to be an investment company under |
| | the Investment Company Act; |
| | Following the reinvestment, the Affiliate Subordinated Debt must |
| | be rated at a minimum equal to the ratings of the ECAPS |
| | immediately prior; |
| | Payment dates of the new Subordinated Debt are the same as the |
| | Distribution Dates of the Trust Preferred Securities; |
| | If LLC I and II are unable to reinvest proceeds in a new |
| | Subordinated Debt meeting the above criteria, LLC I and II may |
| | only invest the proceeds in Eligible Debt Securities. |
| | After the subsequent maturity of the Subordinated Debt in Year 60, LLC I |
| | and II will be liquidated. |

### Appendix C

### Exemplary Terms and Conditions for Deductible PIERS

Issuer [Issuer]

Securities Offered Premium Equity Replacement Securities, with a principal amount of $1,000 per PIERS.

Ranking The PIERS will be subordinated to all senior and subordinated debt of the Issuer but not to trade creditors.

Final Maturity The PIERS will have a final maturity in 60 years.

[Scheduled Maturity: The PIERS will have a scheduled maturity in 30-40 years. The Issuer will use its commercially reasonable efforts to raise sufficient net proceeds from the sale of qualifying capital securities to repay the PIERS in full. Failure to repay the PIERS will be a breach of covenant, but not an event of default and the Issuer will have an ongoing obligation to repay the PIERS with the proceeds of qualifying capital securities on each succeeding interest payment date.]

Interest Rate [ ]% for the PIERS, payable semi-annually in arrears, unless deferred as discussed below under “Deferral of Interest.”Upon any deferral of interest, the Issuer will not be permitted to make payments on or repurchase any of its common stock, preferred stock or debt securities or guarantees having the same rank as or ranking junior to the PIERS.

Following the Scheduled Maturity Date, the interest rate for the PIERS will be reset to LIBOR plus [ ]% (the comparable Issuer floating debt rate at issue plus 100 basis points).

Deferral of Interest Interest on PIERS can be optionally deferred for up to 20 semi-annual interest periods. If a Mandatory Trigger Event occurs, the Issuer may not pay interest on the PIERS except out of proceeds from the sale of common stock, warrants or preferred stock as described below. Interest will continue to accrue on the PIERS during a deferral period at the same rate, compounded semi-annually.
After five years of optional deferral or upon the occurrence of any Mandatory Trigger Event, the Issuer is required, absent a market disruption event, to sell common stock or net share settled warrants with at a strike price premium or qualifying preferred stock, or Depositary Shares representing the right to receive such preferred stock, limited to no more than 25% of the aggregate initial principal amount of the PIERS (the “Preferred Stock Cap”). Notwithstanding the foregoing, in no event will the Issuer be required to sell common stock or warrants to the extent the number of underlying shares would exceed [ ] million (the “Warrant Cap”). Any failure by the Issuer to sell common stock, warrants and/or preferred stock when required, other than as a result of a market disruption event, the Warrant Cap, or the Preferred Stock Cap, shall be a breach of covenant under the indenture, but it will not constitute an event of default thereunder.
The Issuer will covenant in the indenture for the PIERS that following the required sale of warrants or preferred stock upon the occurrence of a Mandatory Trigger Event, the Issuer will not repurchase any of those warrants or any common stock or preferred stock until one year following the final date any such warrants or preferred stock are sold.
All deferred interest, including interest thereon, must be paid no later than the tenth anniversary of the beginning of the deferral period. If there is a failure to pay interest beyond the 10^{th} anniversary of the commencement of any deferral period or the Issuer otherwise fails to pay principal when required, the holders may accelerate the principal of the PIERS or otherwise enforce their creditors' rights.
Upon any bankruptcy of the Issuer, claims in respect of any interest accrued on the PIERS that is unpaid as a consequence of a Mandatory Trigger Event that had persisted in excess of two years at the time of such accrual (including compounded interest thereon) will be extinguished.

Mandatory Trigger Event A Mandatory Trigger Event will have occurred with respect to any interest period if on the 30^{th} day prior to the interest payment date for such period:
The Leverage Ratio is equal to or greater than [ ] for each of the three most recently completed fiscal quarters; and
The Interest Coverage Ratio is equal to or less than [ ] for each of the three most recently completed fiscal quarters.

“Leverage Ratio” means:

Adjusted Debt
(̅A̅d̅j̅u̅s̅t̅e̅d̅ E̅B̅I̅T̅D̅A̅*̅4̅)̅ +̅ A̅n̅n̅u̅a̅l̅i̅z̅e̅d̅ R̅e̅n̅t̅ E̅x̅p̅e̅n̅s̅e̅

“Interest Coverage Ratio” means:

(Adjusted EBITDA*4) + (⅓*Annualized Rent Expense)
(Adjusted Interest*4) + (⅓*Annualized Rent Expense)

“Adjusted Debt” means Long-term debt and commercial paper +Long-term debt due within one year +7× Annualized rent expense+Any amounts sold under an Accounts Receivable Facility (does not include any preferred stock).
“Adjusted EBITDA” means Quarterly net income +Quarterly tax expense+Adjusted Interest Expense+Quarterly depreciation and amortization.
“Adjusted Interest Expense” means Quarterly debt interest expense from the income statement+any debt extinguishment costs not included in quarterly debt interest expense+Quarterly cost of sale of accounts receivable (if there is an accounts receivable facility). For the avoidance of doubt, Adjusted Interest Expense shall include the amount of any accrued and unpaid deferred interest, whether optionally or mandatorily deferred.
[TBU depending on type of Issuer]

Contingent Interest Beginning with the semi-annual interest period commencing ______, ______ [the [3^{rd}/5^{th}] anniversary of the issuance of the PIERS] and ending with the last semi-annual interest period beginning prior to the [30]^{th} Anniversary, if the trading price of the PIERS for each of the five trading days ending on the second trading day immediately preceding the first day of the applicable semi-annual interest period exceeds [125]% of the principal amount of the PIERS for that semi-annual interest period, then the interest rate on the PIERS will increase by an amount equal to 25 bps multiplied by the average trading price of $1,000 principal amount of PIERS during the five trading days immediately preceding the first day of the applicable semi-annual interest period.

Optional Redemption The Issuer may redeem the PIERS at par, plus all accrued and unpaid interest, including any deferred interest, upon not less than 30 days' nor more than 60 days' notice only under the following circumstances:
beginning [three/five] years from the issue date, at any time following any period of 20 trading days within any period of 30 consecutive trading days where the closing price of Issuer common shares on the New York Stock Exchange or any other nationally recognized securities exchange exceeds 130% of the then prevailing Conversion Price;
at any time beginning 30 years from the issue date;

Provided that the Issuer may not redeem the PIERS while there is any unpaid deferred interest.

Capital Replacement Upon Optional Redemption Prior to any optional redemption of the PIERS and/or perpetual preferred stock prior to the Scheduled Maturity Date, the Issuer intends to sell securities with equal or greater equity credit in the aggregate than the PIERS or perpetual preferred stock, as the case may be.

[Capital Replacement Upon Scheduled Maturity From and after the Scheduled Maturity Date, the Issuer may only repay the PIERS and/or perpetual preferred stock with the proceeds from the sale of qualifying capital securities as described in the Capital Replacement Covenant.

Capital Replacement Covenant The Issuer will agree in a covenant for the benefit of holders of specified indebtedness that the PIERS and the perpetual preferred stock issuable upon conversion of the PIERS may only be redeemed, repaid or repurchased from and after the Scheduled Maturity Date and prior to the 50^{th} anniversary of the issuance of the PIERS with proceeds from the issuance of a qualifying capital security with equal or greater equity content than the PIERS and perpetual preferred stock, as the case may be.]

Events of Default It will be an event of default and holders of PIERS will have the right to accelerate the principal thereof if any of the following occur:
Default in payment of principal when due;
Default in payment of interest, including compounded interest, in full for a period of 30 days following the conclusion of a 10-year deferral period; or
Certain events of bankruptcy, insolvency and reorganization involving the Issuer.

Conversion Right At any time prior to the Scheduled Maturity Date, unless earlier redeemed, the holders of PIERS shall have the right to convert the PIERS into shares of perpetual preferred stock issued by Issuer and, if applicable, shares of Issuer common stock.
The PIERS will be convertible based on an initial conversion rate of [ ] shares of Issuer common stock for each $1,000 in principal amount of PIERS (equivalent to an initial conversion price of approximately $[ ] per share of Issuer common stock), subject to customary anti-dilution adjustments. Upon conversion, holders of PIERS will receive for each $1,000 principal amount of PIERS:
   $1,000 liquidation preference of perpetual preferred stock issued by the Issuer with the terms described below under “Preferred Stock” or Depositary Shares representing the right to receive such perpetual preferred stock, provided that upon any conversion following a notice of redemption of the PIERS, holders shall receive $1,000 cash in lieu of perpetual preferred stock;
   if the product of the applicable stock price and the conversion rate then in effect exceeds $1,000, a number of shares of Issuer common stock equal to (i) (a) the conversion rate then in effect multiplied by (b) the applicable stock price, (c) minus $1,000, divided by (ii) the applicable stock price.
The “applicable stock price” means the average closing sale price of a share of Issuer common stock over the 20 trading-day period (the “stock settlement averaging period”) beginning on the trading day immediately following the conversion date.
The settlement date will occur 23 trading days after the conversion date.

Preferred Stock Upon any applicable conversion of PIERS, the perpetual preferred stock received by holders will have the following terms:
a cumulative dividend rate equal to [x % of] the interest rate of the PIERS (including the interest rate increase in year 30), with the same mandatory deferral provisions and obligation to sell common stock, warrants and/or preferred stock;
any deferred interest on the PIERS will be payable on the perpetual preferred stock, subject to the right to continue the deferral;
redeemable in cash at a price equal to the liquidation preference at any time and upon any optional redemption of the PIERS, the perpetual preferred stock must be redeemed on the date 30 calendar days following any optional redemption date for the PIERS; and
the same capital replacement intention as the PIERS.

Remarketing of Perpetual Preferred Unless the perpetual preferred stock has been previously redeemed or called for redemption, holders may elect, following an Issuer

Stock change of control, to have their perpetual preferred stock placed by a placement agent with the following terms:
a dividend rate that will be reset to the rate determined by the placement agent as the rate necessary for the perpetual preferred stock to have a market value at least equal to the liquidation preference plus the placement agent fee, with no dividend reset provision (the dividend rate may be either fixed or a LIBOR-based floating rate at the option of the Issuer)
optional redemption provisions specified by the Issuer prior to the date of the placement.
Any perpetual preferred stock that is not remarketed will also receive the reset rate. Except as set forth above, the terms of the perpetual preferred stock will remain the same following the placement.
If the placement agent cannot place the remarketed preferred security at a price of $1,000 plus accrued and unpaid dividends to the placement date prior to the 40^{th} business day following the event triggering the remarketing, a “failed placement” will be deemed to occur.
Upon a failed placement, investors who have elected to place their perpetual preferred stock will retain such stock and the dividend rate on all perpetual preferred stock (whether or not the holder elected to remarket) will be reset and the perpetual preferred stock will be redeemable at any time by the Issuer. The reset rate will equal LIBOR plus [ ] bps (the “Stated Spread”) [equivalent to the spread over LIBOR at issue of the Issuer comparable floating rate yield at issue plus 100 bps].

Change of Control Make-whole If a change of control of Issuer occurs in which 10% or more of the consideration received by holders consists of anything other than common stock listed on a U.S. national securities exchange, the conversion rate of the PIERS converted in connection with such change of control will increase pursuant to a table of predetermined values (“change of control make whole”), with a minimum value of $1,000, as is customary for a convertible security. All of the other debt instruments of the Issuer outstanding that are senior to the PIERS have provisions that allow the holders thereof to require repayment upon any change of control.

Increase in Conversion Rate After the [5^{th}] anniversary and prior to the [30]th anniversary of the issuance of the PIERS, if for 20 trading days (whether or not consecutive) in the period of 30 consecutive trading days ending on the last trading day of a fiscal quarter of the Issuer, the closing price of the Issuer common stock on the New York Stock Exchange or any other nationally recognized exchange exceeds [200%] of the then prevailing Conversion Price, then beginning with the first day of the next fiscal quarter (and only for such fiscal quarter), the conversion rate on the PIERS will increase at the per annum rate of % [comparable yield at issue plus 100 basis points], with such increase to take effect, unless the PIERS have previously been redeemed, on the last day of such fiscal quarter.

Anti-Dilution Protection The conversion rate will be subject to customary anti-dilution adjustments, including Dividend Protection as described below.

Dividend Protection The conversion rate will be adjusted for distributions of cash by the Issuer to common shareholders, excluding any dividend or distribution in connection with its liquidation, dissolution or winding up.
If the Issuer makes a dividend or distribution as described above, then the conversion rate will be adjusted by multiplying the conversion rate then in effect by a fraction:
   the numerator of which will be the current market price of the common stock; and
   the denominator of which will be the current market price of the common stock minus the amount per share of such dividend or distribution.

Tax Treatment The holders will agree to treat the PIERS as contingent payment debt instruments for purposes of the U.S. Internal Revenue Code.

Accounting Treatment For Income Statement purposes, the PIERS will be treated under the “net share settlement” method of accounting so that additional shares of common stock will only be included in the diluted share count to the extent that the conversion value of the PIERS exceeds $1,000. PIERS will appear as convertible junior subordinated debentures on the Issuer's balance sheet.

We claim:

1. A security that: (a) is tax deductible; (b) receives equity credit of 40-75% from Moody's and S&P; and (c) qualifies for net share settled accounting.

2. A security as in claim 1, wherein said security is a preferred income equity replacement security.

3. A security as in claim 1, wherein said security has a final maturity of 60 years or more.

4. A security as in claim 1, wherein said security has a scheduled maturity of 30 years or more.

5. A security as in claim 1, wherein said security is subordinated to all senior and subordinated debt of an issuer of said security but is not subordinated to claims of trade creditors.

6. A security as in claim 1, wherein after a first period of time or after a mandatory trigger event, an issuer of said security is required to sell stock or warrants, subject to a preferred stock cap and a warrant cap, to pay interest on said security.

7. A security as in claim 6, wherein a mandatory trigger event is defined to include a leverage ratio exceeding a threshold for a second period of time.

8. A security as in claim 6, wherein a mandatory trigger event is defined to include an interest coverage ratio being less than a threshold for a third period of time.

9. A security as in claim 1, wherein said security has a contingent interest feature.

10. A security as in claim 4, wherein holders of said security have a right, at any time prior to said scheduled maturity date, to convert said security for shares of perpetual preferred stock issued by an issuer of said security and a number of shares of common stock if a product of an applicable stock price and a conversion rate exceeds a liquidation preference amount of said perpetual preferred stock, wherein said number of shares of common stock is based on a formula comprising said applicable stock price, said conversion rate, and said liquidation preference amount.

11. A security as in claim 10, wherein upon conversion, holders of said security receive, for each principal amount of said security, a liquidation preference amount of perpetual preferred stock, on the condition that upon conversion following the occurrence of an event, said holders receive cash in lieu of said liquidation preference amount of perpetual preferred stock.

12. A security as in claim 11, wherein said event comprises a notice of redemption of said security.

13. A security as in claim 10, wherein said perpetual preferred stock has one or more of the following characteristics:
(a) a cumulative dividend rate equal to or less than the interest rate paid on said security;
(b) mandatory deferral provisions corresponding to mandatory deferral provisions of said security;
(c) deferred interest on said security is payable on said perpetual preferred stock;
(d) redeemable in cash at a price equal to a liquidation preference;
(e) must be redeemed on a date following an optional redemption date of said security; and
(f) a capital replacement intention corresponding to a capital replacement intention of said security.

14. A method comprising:
structuring a convertible security to be tax deductible;
structuring said convertible security to receive equity credit of 40-75% from Moody's and S&P;
structuring said convertible security to qualify for net share settled accounting; and
issuing said security.

15. A method as in claim 14, further comprising structuring said security as a preferred income equity replacement security.

16. A method as in claim 14, further comprising structuring said security to have a final maturity of 60 years or more.

17. A method as in claim 14, further comprising structuring said security to have a scheduled maturity of 30 years or more.

18. A method as in claim 14, wherein said security is subordinated to all senior and subordinated debt of an issuer of said security but is not subordinated to claims of trade creditors.

19. A method as in claim 14, wherein after a first period of time or after a mandatory trigger event, an issuer of said security is required to sell stock or warrants, subject to a preferred stock cap and a warrant cap, to pay interest on said security.

20. A method as in claim 19, wherein a mandatory trigger event is defined to include a leverage ratio exceeding a threshold for a second period of time.

21. A method as in claim 19, wherein a mandatory trigger event is defined to include an interest coverage ratio being less than a threshold for a third period of time.

22. A method as in claim 14, wherein said security has a contingent interest feature.

23. A method as in claim 17, wherein holders of said security have a right, at any time prior to said scheduled maturity date, to convert said security for shares of perpetual preferred stock issued by an issuer of said security and a number of shares of common stock if a product of an applicable stock price and a conversion rate exceeds a liquidation preference amount of said perpetual preferred stock, wherein said number of shares of common stock is based on a formula comprising said applicable stock price, said conversion rate, and said liquidation preference amount.

24. A method as in claim 23, wherein upon conversion, holders of said security receive, for each principal amount of said security, a liquidation preference amount of perpetual preferred stock, on the condition that upon conversion following the occurrence of an event, said holders receive cash in lieu of said liquidation preference amount of perpetual preferred stock.

25. A method as in claim 24, wherein said event comprises a notice of redemption of said security.

26. A method as in claim 23, wherein said perpetual preferred stock has one or more of the following characteristics:
(a) a cumulative dividend rate equal to or less than the interest rate paid on said security;
(b) mandatory deferral provisions corresponding to mandatory deferral provisions of said security;
(c) deferred interest on said security is payable on said perpetual preferred stock;
(d) redeemable in cash at a price equal to a liquidation preference;
(e) must be redeemed on a specified date following an optional redemption date of said security; and
(f) a capital replacement intention corresponding to a capital replacement intention of said security.

27. A method comprising:
(a) purchasing a security with a scheduled maturity date of 30 years or more;
(b) redeeming said security prior to said maturity date for a first number of shares of perpetual preferred stock and a second number of shares of common stock; and
(c) receiving cash in lieu of said first number of shares of perpetual preferred stock.

28. A method as in claim 27, wherein said security: (a) is tax deductible; (b) receives equity credit of 40-75% from Moody's and S&P; and (c) qualifies for net share settled accounting.

29. A method as in claim 27, wherein said security is a preferred income equity replacement security.

30. A method as in claim 27, wherein said security has a final maturity of 60 years or more.

31. A method as in claim 27, wherein said security is subordinated to all senior and subordinated debt of an issuer of said security but is not subordinated to claims of trade creditors.

32. A method as in claim 27, wherein after a first period of time or after a mandatory trigger event, an issuer of said security is required to sell stock or warrants, subject to a preferred stock cap and a warrant cap, to pay interest on said security.

33. A method as in claim 32, wherein a mandatory trigger event is defined to include a leverage ratio exceeding a threshold for a second period of time.

34. A method as in claim 32, wherein a mandatory trigger event is defined to include an interest coverage ratio being less than a threshold for a third period of time.

35. A method as in claim 27, wherein said security has a contingent interest feature.

36. A method as in claim 27, wherein holders of said security have a right, at any time prior to said scheduled maturity date, to convert said security for shares of perpetual preferred stock issued by an issuer of said security and a number of shares of common stock if a product of an applicable stock price and a conversion rate exceeds a liquidation preference amount of said perpetual preferred stock, wherein said number of shares of common stock is based on a formula comprising said applicable stock price, said conversion rate, and said liquidation preference amount.

37. A method as in claim 36, wherein upon conversion, holders of said security receive, for each principal amount of said security, a liquidation preference amount of perpetual preferred stock, on the condition that upon conversion following the occurrence of an event, said holders receive cash in lieu of said liquidation preference amount of perpetual preferred stock.

38. A method as in claim 37, wherein said event comprises a notice of redemption of said security.

39. A method as in claim 36, wherein said perpetual preferred stock has one or more of the following characteristics:
(a) a cumulative dividend rate equal to or less than the interest rate paid on said security;
(b) mandatory deferral provisions corresponding to mandatory deferral provisions of said security;
(c) deferred interest on said security is payable on said perpetual preferred stock;
(d) redeemable in cash at a price equal to a liquidation preference;
(e) must be redeemed on a date following an optional redemption date of said security; and
(f) a capital replacement intention corresponding to a capital replacement intention of said security.
